(19) United States
(12) Patent Application Publication
(10) Pub. No.: US 2007/0147425 A1
(43) Pub. Date: Jun. 28, 2007

(54) Wireless modem

(75) Inventors: Pierre Lamoureux, St-Lazare (CA); Genevieve Cyr, Laval (CA); Thierry De Corte, Laval (CA); Ho-Kuo Chan, Pierrefonds (CA); Donald Stevenson, Kirkland (CA)

Correspondence Address: BERESKIN AND PARR, 40 KING STREET WEST, BOX 401, TORONTO, ON, M5H 3Y2, US

(73) Assignee: WAVESAT, Dorval (CA)

(21) Appl. No.: 11/318,523

(22) Filed: Dec. 28, 2005

(51) Int. Cl. H04J 3/16; H04J 3/22

(52) U.S. Cl. 370/469; 370/463

(57) ABSTRACT

A wireless modem includes an RF module adapted to be connected to an antenna, comprising an intermediate frequency input and an intermediate frequency output, a PHY module receiving the intermediate frequency output and generating the intermediate frequency input, and a low level media access control (LL-MAC) module connected to the PHY and using a direct memory access (DMA) connection for data exchange with a high level media access control module (HL-MAC). A direct memory access (DMA) to computer bus interface module is adapted to be connected to the DMA connection of the LL-MAC and to a computer bus. The DMA interface module responds to the LL-MAC as memory and is adapted to cooperate with the HL-MAC connected to the computer bus. The architecture allows for a modem to be placed on a mini-PCI module with the HL-MAC residing in software on a host computer.

### FIELD OF THE INVENTION

The invention relates generally to the field of wireless communication systems, and more specifically to wireless modems.

### BACKGROUND OF THE INVENTION

Currently there are many types of network access services that are available. Cable and DSL broadband access services are two services whose popularity has increased greatly over the past few years. As a result, a great number of people and communities have been able to access the Internet. However, even as broadband systems have gained in popularity, there remain a large number of areas throughout the world that are unable to access broadband connectivity. DSL connectivity generally requires a central office, and DSL connections may generally only be made within short distances form the central office switch (i.e. less than four miles).

Due to the limitations associated with cable and DSL, various wireless access methods have been proposed and developed in an attempt to provide network access services to a greater number of people. In order to connect to a wireless access system, the host computer from which access is requested is required to be connected to a wireless modem. Wireless modems (also referred to RF modems) are generally comprised of an RF transceiver, a baseband chip used to modulate and demodulate received signals, a CPU, and an interface that allows for connectivity to the local host machine, and a memory store. The components of the modem operate so as to receive and transmit electromagnetic signals. When receiving an RF signal, the received signal is processed to determine the contents of the information that has been encapsulated within the signal transmission. Received RF signals are generally encapsulated with data that is not to be construed as part of the information transmittal, and therefore such data (i.e. packet headers) needs to be removed and such removal of data is preformed by the processor associated with the modem. The interface associated with such a modem interacts with the host computer and host-computing environment to receive and transmit data.

Many wireless network access technologies are faced however, with similar limitations to those that are faced by wireless technologies in relation to both performance and capacity. One standard that has been proposed and developed to overcome the limitations that are associated with other wired and wireless methods is WiMAX (IEEE 802.16). WiMAX is a broadband wireless technology that is able to cover a large geographic area, one that is up to 50 kilometers in radius and is able to deliver broadband wireless access of up to 72 Mbps. Other wireless technologies are generally able to only provide line-of-sight (LOS) coverage however, WiMAX due to its use of OFDM (Orthogonal Frequency Division Multiplexing) is able to provide connectivity access up to 15 kilometers away in NLOS (Non Line of Sight) conditions, and in LOS conditions provides transmissions in the 50 kilometer range.

However, even with such technologies such as WiMAX and other wireless transmission protocols the cost of manufacturing and developing the hardware remains high. One area of focus within wireless modems to make them more efficient and more inexpensive to manufacture, is the media access control (MAC) layer. The MAC layer protocol controls how a computer gains access to data and grants permission to transmit data. Referring to the Open System Interconnection (OSI) model for networking, the OSI model defines a networking framework for implementing protocols in seven layers where each of the seven layers may provide for one or more programs to support a specific type of OSI process, where the MAC layer is one of the layers.

Wireless modems have the MAC functions performed by a processor located on the wireless modem. As a result, the processing time associated with the MAC functions exhausts the resources of the modems, and as a result wireless modems become more expensive to manufacture.

### SUMMARY OF THE INVENTION

In one broad aspect there is provided a wireless modem comprising an RF module adapted to be connected to an antenna, comprising an intermediate frequency input and an intermediate frequency output; a low level media access control (LL-MAC) module receiving: said intermediate frequency output and generating said intermediate frequency input, said low level media access control (LL-MAC) module using a direct memory access (DMA) for data exchange with a high level media access control module (HL-MAC); and a direct memory access (DMA) to computer bus interface module adapted to be connected to said DMA interface and to a computer bus, said DMA interface module responding to said LL-MAC as memory and adapted to cooperate with said HL-MAC connected to said computer bus.

In another broad aspect there is provided a method of manufacturing wireless modems comprising: providing an RF module adapted to be connected to an antenna, comprising an intermediate frequency input and an intermediate frequency output; providing a low level media access control (LL-MAC) module receiving: said intermediate frequency output and generating said intermediate frequency input, said low level media access control (LL-MAC) module using a direct memory access (DMA) for data exchange with a high level media access control module (HL-MAC); and providing a direct memory access (DMA) to computer bus interface module adapted to be connected to said DMA interface and to a computer bus, said DMA interface module responding to said LL-MAC as memory and adapted to cooperate with said HL-MAC connected to said computer bus.

### BRIEF DESCRIPTION OF THE DRAWINGS

For a better understanding of embodiments of the systems and methods described herein, and to show more clearly how they may be carried into effect, reference will be made by way of example, to the accompanying drawings in which:

FIG. 1 is a block diagram of the general components of a wireless modem according to one embodiment of the invention;

FIG. 2 is a block diagram of the components of a wireless modem of a second embodiment of the invention; and

FIG. 3 is a more detailed block diagram of the components of the low level MAC processor and the high level MAC processor of the embodiment of FIG. 2.

### DETAILED DESCRIPTION OF THE INVENTION

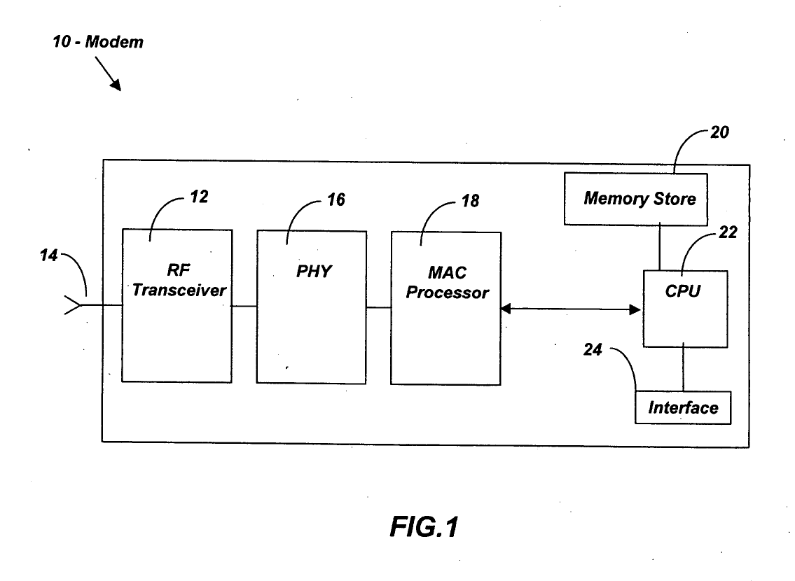

Reference is made to FIG. 1, where the general components of a prior art wireless modem are shown. The wireless modem 10 of FIG. 1 is meant to provide an example of the general components and the general functionality associated with wireless modems. Wireless modems are designed to be able to interface with a host computer. The wireless modems are then able to transmit their received signals from a respective network source, to the host computer so that the appropriate processing steps may be undertaken.

Wireless modems are generally comprised of an RF module 12, an antenna 14, a physical layer (PHY) 16 for baseband processing (provided on an ASIC), a media access control (MAC) processor 18, a memory store 20, a central processing unit 22, and an interface 24.

The RF module 12 further comprises, or is connected to an RF switch, an RF transmitter, and an RF receiver. The term RF is used to refer to the electromagnetic waves that are used in radio communication. Radio waves are classified according to their respective frequencies. Radio frequencies may range from a very low frequency (VLF), which has a range of 10 to 30 kHz, to an extremely high frequency (EHF), which has a range of 30 to 300 GHz. The RF transceiver is the source of the RF energy that the antenna 14 transmits and receives.

The antenna 14 when transmitting a signal, receives RF current that is supplied to it, and generates an electromagnetic field that is used to transmit the signal. The RF module 12, and more specifically the RF transmitter module is the source of the current supplied to the antenna 14.

The RF module 12 facilitates the wireless data reception and transmission from and to the wireless modem 10. The RF receiver is used to receive RF signals that are input to the wireless modem 10. The RF transmitter 26 includes an amplifier and tuning circuits that supply power to the RF module 14.

The PHY chip 16 also has the ability to work with different IF signal formats of the RF transceiver 12, as is described in greater detail in commonly owned co-pending U.S. patent application filed herewith bearing the title “Signal Processing within a Wireless Modem” and agent docket number 15031-5, the specification of which is incorporated herein by reference.

The PHY chip 16 also controls attributes of the RF section 12. In some embodiments, an interface between PHY 16 and RF transceiver 12 is included, as is described in greater detail in commonly owned co-pending U.S. patent application filed herewith bearing the title “Wireless Modem” and agent docket number 15031-6, the specification of which is incorporated herein by reference.

The MAC processor 18 is responsible for performing timing critical operations for the central processing unit and to serve as an interface between the physical layer (PHY) chip 16 and the central processing unit 20. The MAC processor 18 is provided by an FPGA. The MAC processor 18 is also responsible for the determination, insertion and removal of message fields associated with the appropriate transmission protocol.

The MAC processor 18 is responsible for various real time functions, which include but are not limited to any one of the following functions: frame verification, implementing an acknowledgement protocol, generating a MAC header, and encryption and decryption of data transmitted to and from the MAC processor. The MAC processor 18 also performs the following non real time functions, which may include but are not limited to any one of the following: specifying the transmission, speed of retransmittal of data, and multicast filtering. The central processing unit 22 implements the appropriate transmission protocol the wireless modem operates upon, and the physical layer chip 16 allows for the implementation of the protocol used in the wireless transmission.

The interface 24 allows for the wireless modem 10 to connect to a host computer or device it is associated with. The interface may allow the wireless modem to be external to the host computer (i.e. an Ethernet connection) or may be ones that require the wireless modem to be internal with respect to the host computer (i.e. PCI, etc).

Wireless modems are most often found in computing devices that are portable, such as laptop computers, and other portable computing devices. The peripheral interconnect (PCI) bus, is a 32 bit bus that generally operates at 33 or 66 MHz. Many wireless modems make use of PCI to interface with the host device. The PCI bus provides support for bus mastering.

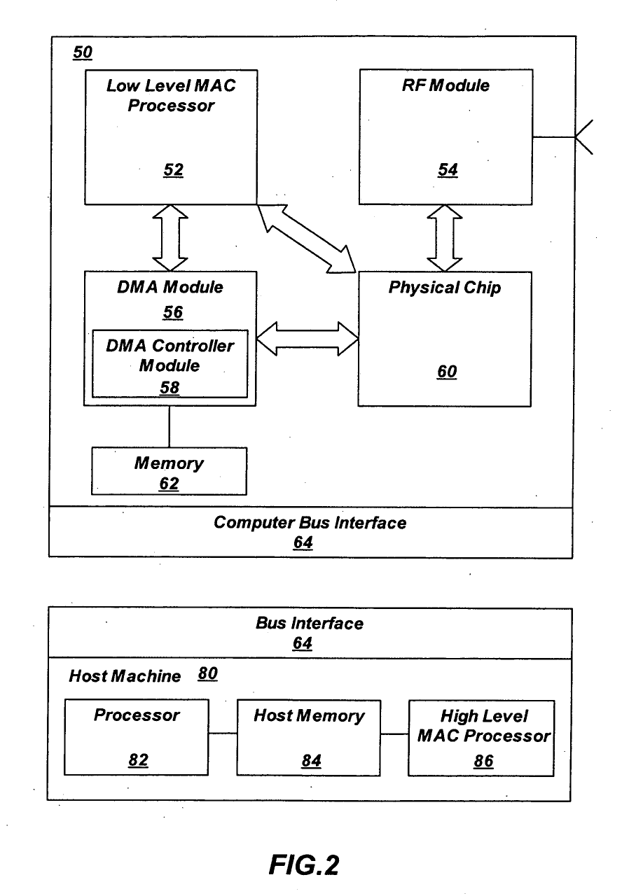

Reference is now made to FIG. 2, where the wireless modem 50 of the present invention is illustrated. The wireless modem 50 as described in FIG. 2, is described with respect to a modem that interfaces with a host machine 80 through an interface on a motherboard of the host machine. The wireless modem 50 of the present invention is comprised of a low level MAC processor 52, an RF module 54, a direct memory access (DMA) module 56, a direct memory access (DMA) controller module 58, a physical chip 60, a memory store 62, and a computer bus interface 64.

The wireless modem 50 interfaces with a host computer 80. The host computer 80 may be any computing device, however, it will generally be representative of a portable computing device (i.e. a laptop, handheld computer, WiFi access point, router). The host computer will comprise among other components a central processor 82, a host memory store 84, a high level media access control module 86, which is implemented as software in an exemplary embodiment. It will be well understood to one of skill in the art that the host computer includes additional components than the ones that have been mentioned above.

The wireless modem 50 for purposes of data transmission relies on orthogonal frequency domain multiplexing (OFDM). OFDM is a multi carrier system that transmits a single data stream over lower rate sub carriers. OFDM offers many advantages over other carrier systems, including multi path effect immunity, channel equalization and timing acquisition constraints.

The wireless modem 50 of the present invention, employs two MAC processors, and thus divides the functionality of the general MAC processor, both the real time and non real time tasks, so as to allow for more efficient processing.

The low level MAC processor 52 found on the wireless modem 50 will generally be responsible for performing timing critical MAC operations The low level MAC processor 52 implements the timing critical operations of the MAC but it also may implement other MAC functions such as decryption, Encryption and Transport Messaging. The low level MAC processor 52 may be a processor that is designed to implement the protocols associated with different wireless transmission protocols. The low level MAC processor 52 includes the core of the PCI controller interface. The low level MAC processor 52 as described here implements a portion of IEEE 802.16-2004 wireless protocol.

The DMA module 56 allows for the control of any memory associated with the wireless modem 50. Based on a request, the module 56, and more specifically the DMA controller module 58 will move data from one location in memory to another. The use of the DMA module 56 is more efficient than using the CPU to manage data transfers. A DMA transfer copies a block of memory from one memory location to the other. In order to ensure that the data is processed efficiently, the data buffers (not shown) associated with the low level MAC processor 52 are large enough to handle any response latency that may be generated by the high level MAC processor module 86. In order to minimize the latency that may result from the processing operations performed by the high level MAC processor module 86, the host computer 80 will generally employ a real time operating system.

The advantages of using DMA are known in the art. Direct memory access (DMA) allows certain hardware subsystems within a computer to access system memory for reading and/or writing independently of the CPU. Many hardware systems use DMA including disk drive controllers, graphics cards, network cards, and sound cards. DMA transfers are valuable to high performance embedded systems such as modems, and DMA is a core feature of computers, as it allows devices of different speeds to communicate without subjecting the CPU to a massive interrupt load. Otherwise, the CPU would have to copy each piece of data from the source to one of its registers, and then write it back again to the new location. During this time the CPU would be unavailable for other tasks. A DMA transfer essentially copies a block of memory from one device to another. While the CPU initiates the transfer, the transfer itself is performed by the DMA Controller. A typical example is moving a block of memory from external memory to faster, internal (on-chip) memory. Such an operation does not stall the processor, which as a result can be scheduled to perform other tasks.

By using DMA to transfer data between the LL-MAC 52 and the HL-MAC 86, certain efficiencies are gained. In the embodiment of FIG. 2, the HL-MAC 86 is provided in software executed on the host machine 80 and the LL-MAC 52 exchanges data efficiently with the HL-MAC 86. In other embodiments, the LL-MAC may exchange data between the CPU's cache memory or another memory chip without burdening the computer bus 64.

DMA module 56 provides a DMA to computer bus interface. This interface is seen by LL-MAC 52 as DMA memory that will respond quickly to data transfer requests. Thus, the LL-MAC 52 has control over the DMA module 56. Meanwhile, DMA controller module 58 manages the transfer of the data blocks over the computer bus 64, such as a PCI bus, in a manner that does not burden the computer bus. Thus, data received over the air is written into a buffer 62 with minimal delay and then transferred over the computer bus to HL-MAC 86 quickly but in accordance with the computer bus' availability. Likewise, data sent over the air is transferred over the computer bus quickly but in accordance with bus availability to the module 56, and the LL-MAC 52 receives the data to be transmitted as it desires by DMA transfer.

The physical layer (PHY) chip 60 is used to implement the appropriate wireless transmission and reception protocol. The PHY chip 60 is used for carrying out signal processing functions, including the selection and generation of different signal types and the subsequent encoding of signals for transmission. With respect to receipt of signals, the physical chip. 60 is used to decode the transmission that is received as well as convert the received signal into a format (mode) that is required for processing. The physical chip 60 modulates and demodulates the signals according to a selection that is made. The physical chip 60 allows for the implementation of the protocol used to implement broadband wireless access. The physical chip 60 is used to implement Orthogonal Frequency Division Multiplexing.

The physical layer chip 60 is used to perform encoding and modulation of digital data that is received from the low level MAC processor 52. The digital data received from the low level MAC processor is further processed by the physical chip 60 and converted into an OFDM analog signal wish is then transmitted to the RF module 54. The physical layer chip 60 also receives from the RF module 54, the OFDM analog signal that has been received by the modem through the antenna, is demodulated and encoded into digital data and sent to the low level MAC processor 52.

The low level MAC processor 52 and the physical chip 60 transfer data by making use of a dedicated bus. The low level MAC processor 52 and the direct memory access module 58 transfer data through a DMA bus (not shown). The DMA controller module 58 adjust the rate of transmission for data that it transfers to match that of data transfer rates associated with the low level MAC address, which therefore allows for the DMA controller module 58 to represent itself as a master to the low level MAC processor 52. The low level MAC processor 52 in an exemplary embodiment of the invention contains two control registers that are used to interface with the DMA module 56. A first DMA control register that is part of the physical layer chip 60 permits the low level MAC processor 52 to generate a DMA transfer request. The second DMA control register (not shown) that is part of the physical layer chip specifies the width (size) of the DMA transfer.

The wireless modem 50 is able to connect to the host machine through a computer bus 64. The computer bus 64 in one exemplary embodiment is a PCI bus, however, it may also include, but is not limited to an other embodiments it may be a PCI-express bus or USB bus. The operation of the computer bus 70 is described with reference to the PCI bus. The PCI bus operates either in synchronous or asynchronous mode.

In the embodiment of FIG. 2, the RF section 54 is built on a mini-PCI module that also supports the PHY chip 60 and an FPGA. The FPGA chip is configured to provide LL-MAC 52 and the DMA module 56 (including controller 58 and memory 62), and bus interface 64 is also part of the FPGA. A mini-PCI form factor is compact and is able to be “built-in” to a portable computer. The modem 50 is able to fit on such a small module in part due to the lack of a CPU and/or the presence of the HL-MAC 86 that would require significant resources. The LL-MAC 52 is a minimal LL-MAC with all MAC functions that can be done in software being in the HL-MAC 86 to reduce the size of the LL-MAC. Of course, if space permits, parts of the HL-MAC may be ported over to the LL-MAC without changing the architecture. The mini PCI specification has been designed for laptops and other portable computing devices. Mini PCI has been developed as a standard for integrated peripheral devices, that focuses on communication means, and has been developed for laptops, printers, and set top boxes. The mini PCI card is an extension of the PCI bus used in portable computers. Mini PCI cards are meant to interface with the host machine through the motherboard, and not through slots which are located on the outside of a computing device as is the case with PCI cards. One of the main benefits associated with the use of mini PCI cards, is aside from their smaller size, they allow for high-speed data transfer between the host computer and the wireless modem.

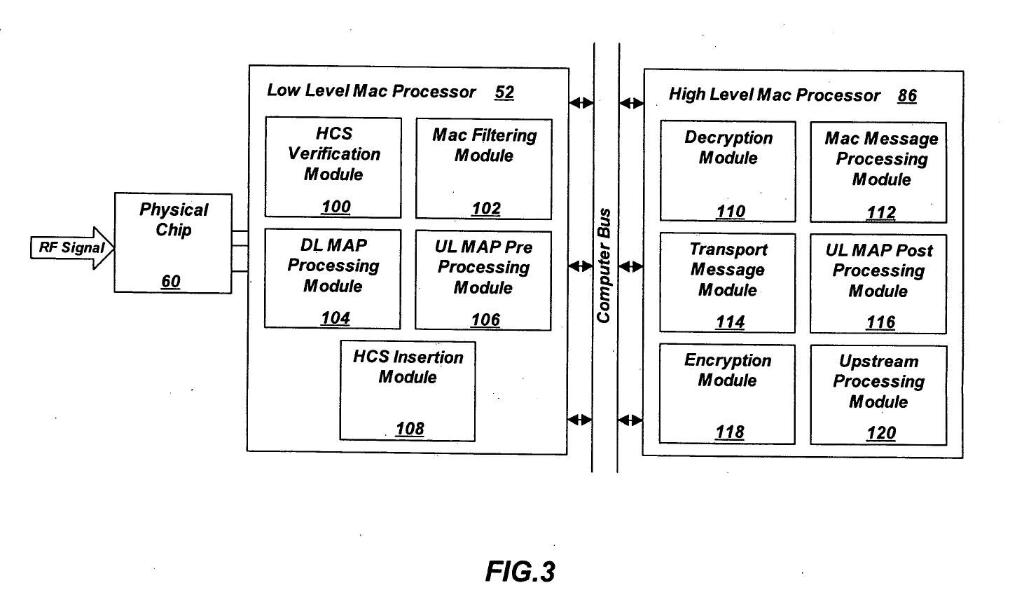

Reference is now made to FIG. 3, where a block diagram of the components contained within the low level MAC processor 52, and the high level MAC processor module 86, which in an exemplary embodiment has been implemented in software, are shown. As mentioned above, a partitioning of the MAC functions attributed to the MAC processing layer of the OSI model are undertaken in the wireless modem 50 that is the subject of this invention. The low level MAC processor 52 will have associated with it a HCS verification module 100, a MAC filtering module 102, a DL MAP processing module 104, an UL MAP pre processing module 106, and a HCS insertion module 108. The components and the functionality they implement are explained in further detail below.

The high level MAC processor module 86 is found as part of the host machine 80. The high level MAC processor module 86 in an exemplary embodiment is implemented as a software application, however, it may also be the case that it is implemented as a hardware application on a dedicated hardware device. The high level MAC processor module 86 is used to implement timing critical operations so as to allow for the MAC functions that are part of the low level MAC processor and more specifically the implementations of MAC functions to be more efficient. The high level MAC processor module 86 will be responsible for many of the non real time operations that the MAC is generally responsible for. The off loading of these specific functions onto the high level MAC processor module 86 allows for the wireless modem to consume less power, occupy less PCB area and be lower in cost. These are important considerations when manufacturing small form factor cards, which may include, but are not limited to mini PCI, mini PCI-express, CardBus, and PCI mezzanine cards (PMC).

The modules contained within the low level MAC processor 52 will now be described in further detail. The HCS verification module 100 is used to detect and correct errors associated with transmission or storage of digital data. Specifically, the HCS module 100 is used to perform a cyclic redundancy check, which is a hash function which generates a checksum. This module allows for the determination that the data was received by the intended recipient and that the data was received in an unaltered form. The MAC filtering module 102 is responsible for ensuring that data is received from approved sources and is destined to the wireless modem. The DL Map processing module 104 decodes the MAP messages from a Base Station that determines the time slot that allows the modem to transmit up link to the Base Station. The UL Map processing module 106 modifies the information from the DL Map processing module 104 into a format that allows the Physical chip 60 to schedule an up link data burst to the Base Station. The HCS insertion module 108 is used to generate checksums which are used in cyclic redundancy checking to ensure data integrity.

The high level MAC processor module 86, as described above is a software based implementation that is used to perform the non-timing critical operations that are performed by the MAC. The high level MAC processor 86 in this exemplary embodiment, will be comprised of, but not limited to, the following components: a decryption module 110, a MAC message processing module 112, a transport message module 114, a UL map post processing module 116, an encryption module 118, and upstream processing module 120.

The decryption module 110 carries out decryption on any transmission that is received by the low level MAC module 52 and is transmitted to the high level MAC module 86 for processing. The MAC message processing module 112 decodes the MAC messages received from the Base station and then performs appropriate processing functions. The Transport Message Module 114 passes the IP packets between an IP stack and the modem. The Uplink MAP post processing module 116 processes the non-time critical portion on an Uplink MAP message, which may include, but are not limited to those messages that change the scheduling of subsequent frames. The encryption module 118 is used to encrypt data that is to be transmitted. The data upon its encryption is then transmitted back to the back to the Low Level MAC processor so that it may be sent to the PHY then the RF module for transmission.

In order to transmit data between the wireless modem 50 and the host system 80, the computer bus 64 is used. Specifically, in the exemplary embodiment provided herein the PCI bus interface is used upon the wireless modem 50. However, it should be understood that the wireless modem 50 may use other interfaces aside from the PCI interface when interfacing with a host machine, examples of which may include but are not limited to, CardBus, PCI Mezzanine Card (PMC), PCMCIA bus, USB bus, Fire Wire Bus, mini-PCI-express bus.

In a computer bus that is used in the implementation of peripherals such as wireless modems, for which mini-pci has been deployed, DMA control signals are generally not present. DMA control signals include signals such as DMA REQUEST, DMA ACKNOWEDLGE, and DMA GRANT. The DMA REQUEST is sent to the DMA controller when a request is being made for DMA service. In PCI buses, these signals are not present, and in order to transfer information over the bus, an IRQ (interrupt request line) signal is present. When an IRQ is issued, the performance of the processors associated with the host computer (i.e. the CPU) are greatly affected, as data throughput is severely limited.

In the exemplary embodiment of the invention, the direct memory access module 56 is provided on the same FPGA as the low level MAC processor 52. Thus for an uplink transmission to take place, the uplink MAP pre-processing module 106 initiates a DMA transfer from host memory module 84 to the HCS insertion module 108. In the downlink direction, the MAC filtering module 102 initiates a DMA transfer from the MAC filtering Module 102 to the host memory module 84. The DMA transfer is implemented by first requesting the computer bus mastership, and then effectuating the appropriate number of data transfers. After completion, the mastership of the Computer bus is relinquished.

The invention has been described with regard to a number of embodiments. However, it will be understood by persons skilled in the art that other variants and modifications may be made without departing from the scope of the invention as defined in the claims appended hereto.

1. A wireless modem comprising:
(a) an RF module adapted to be connected to an antenna, comprising an intermediate frequency input and an intermediate frequency output;
(b) a physical layer (PHY) module receiving said intermediate frequency output and generating said intermediate frequency input;
(c) a low level media access control (LL-MAC) module connected to said PHY module, said low level media access control (LL-MAC) module using a direct memory access (DMA) for data exchange with a high level media access control module (HL-MAC); and
(d) a direct memory access (DMA) to computer bus interface module adapted to be connected to said DMA interface and to a computer bus, said DMA interface module responding to said LL-MAC as memory and adapted to cooperate with said HL-MAC connected to said computer bus.

2. The wireless modem of claim 1 implemented upon a mini PCI module.

3. The wireless modem of claim 1 implemented upon a mini PCI-express module.

4. The wireless modem as claimed in claim 2, wherein said LL-MAC and said DMA to computer bus interface modules are provided on programmable hardware.

5. The wireless modem as claimed in claim 1, wherein said LL-MAC and said DMA to computer bus interface modules are provided on programmable hardware.

6. A wireless modem system comprising:
(a) an RF module adapted to be connected to an antenna, comprising an intermediate frequency input and an intermediate frequency output;
(b) a physical layer (PHY) module receiving said intermediate frequency output and generating said intermediate frequency input;
(c) a computer processor;
(d) a computer bus associated with said processor;
(e) a high level media access control module (HL-MAC) provided in software and executed by said processor;
a low level media access control (LL-MAC) module connected to said PHY module, said low level media access control (LL-MAC) module using a direct memory access (DMA) connection for data exchange with said HL-MAC module; and
(g) a direct memory access (DMA) to computer bus interface module adapted to be connected to said DMA connection of said LL-MAC and to said computer bus, said DMA interface module responding to said LL-MAC as memory and adapted to cooperate with said HL-MAC to transfer data over said computer bus.

7. The wireless modem system of claim 6, wherein said RF module, said PHY, said LL-MAC module and said interface module are implemented upon a mini PCI module.

8. The wireless modem system of claim 6, wherein said RF module, said PHY, said LL-MAC module and said interface module are implemented upon a mini PCI-express module.

9. The wireless modem system as claimed in claim 7, wherein said LL-MAC and said. DMA to computer bus interface modules are provided on programmable hardware.

10. The wireless modem system as claimed in claim 6, wherein said LL-MAC and said DMA to computer bus interface modules are provided on programmable hardware.
